(19) United States
(12) Patent Application Publication
(10) Pub. No.: US 2026/0350719 A1
(43) Pub. Date: Nov. 5, 2026

(54) METHOD FOR DETERMINING ENERGY STORAGE REVENUE, ELECTRONIC DEVICE AND COMPUTER STORAGE MEDIUM

(71) Applicant: CSI ENERGY STORAGE CO., LTD., Suzhou (CN)

(72) Inventors: Shiying SONG, Suzhou (CN); Zhichao HOU, Suzhou (CN); Kai CHEN, Suzhou (CN); Lijun GAO, Suzhou (CN); Meiqi YAO, Suzhou (CN)

(21) Appl. No.: 19/413,238

(22) Filed: Dec. 9, 2025

(30) Foreign Application Priority Data
Mar. 17, 2025 (CN) 202510312706.X

(51) Int. Cl. G06Q 50/06; G06Q 40/06

(52) U.S. Cl. CPC G06Q 50/06; G06Q 40/06

(57) ABSTRACT

A method for determining energy storage revenue, an electronic device and a non-transitory computer storage medium. The method for determining the energy storage revenue includes: obtaining load data of an electricity consumption side and usage performance data of an energy storage product; and determining an energy storage revenue result based on the load data of the electricity consumption side and the usage performance data. The method enables precise calculation of the energy storage revenue result, thereby enhancing the investment accuracy and the investment return rate.

### CROSS-REFERENCE TO RELATED APPLICATION

The present application claims priority to Chinese Patent Application No. 202510312706.X filed with China National Intellectual Property Administration on Mar. 17, 2025 and entitled “METHOD FOR DETERMINING ENERGY STORAGE REVENUE, ELECTRONIC DEVICE AND COMPUTER STORAGE MEDIUM”, which is incorporated herein by reference in its entirety.

### FIELD

The present disclosure relates to the field of energy storage revenue calculation technology, and more particularly, to a method for determining energy storage revenue, an electronic device and a non-transitory computer storage medium.

### BACKGROUND

Traditional energy storage system configurations are often based on empirical values, making it difficult to accurately calculate the investment and revenue, which in turn affects the accuracy and the return rate of the investment.

### SUMMARY

The present disclosure aims to provide a method for determining energy storage revenue

A second aim of the present disclosure is to provide an electronic device.

A third aim of the present disclosure is to provide a non-transitory computer storage medium.

An embodiment of a first aspect of the present disclosure provides a method for determining energy storage revenue. The method includes: obtaining load data of an electricity consumption side and usage performance data of an energy storage product; and determining an energy storage revenue result based on the load data of the electricity consumption side and the usage performance data.

The method for determining energy storage revenue according to the embodiment of the present disclosure analyzes and calculates the actual load data of the electricity consumption side and the usage performance data of the energy storage product and precisely calculates the energy storage revenue result, thereby enhancing the investment accuracy and the investment return rate.

In some embodiments, the determining the energy storage revenue result based on the load data of the electricity consumption side and the usage performance data includes: determining a target investment quantity of energy storage products based on the load data of the electricity consumption side; and determining the energy storage revenue result for the target investment quantity of energy storage products based on the load data of the electricity consumption side and the usage performance data.

In some embodiments, the load data of the electricity consumption side at least includes a first electricity load of the electricity consumption side during an off-peak period and a second electricity load of the electricity consumption side during a super-peak period. The determining the target investment quantity of the energy storage products based on the load data of the electricity consumption side includes: acquiring the first electricity load and the second electricity load periodically with a first preset duration as a cycle; determining a first available charging capacity periodically based on a transformer capacity and the first electricity load; accumulating the first available charging capacity determined in each cycle to obtain a total charging capacity at the electricity consumption side during the off-peak period; accumulating the second electricity load determined in each cycle to obtain a required total discharging capacity of the electricity consumption side during the super-peak period; and determining the target investment quantity based on the total charging capacity and the required total discharging capacity.

In some embodiments, the determining the target investment quantity based on the total charging capacity and the required total discharging capacity includes: determining a first quantity value based on the total charging capacity and a rated capacity of an individual energy storage product; determining a second quantity value based on the required total discharging capacity and the rated capacity of the individual energy storage product; and determining the target investment quantity based on the first quantity value and the second quantity value.

In some embodiments, the determining the target investment quantity based on the first quantity value and the second quantity value includes determining the target investment quantity based on a minimum value between the first quantity value and the second quantity value.

In some embodiments, the target investment quantity satisfies: a first investment quantity≤the target investment quantity≤a second investment quantity, where the first investment quantity=the minimum value−a preset value, and the second investment quantity=the minimum value+the preset value.

In some embodiments, the determining the energy storage revenue result for the target investment quantity of energy storage products based on the load data of the electricity consumption side and the usage performance data includes: determining an actual total charging capacity of the target investment quantity of energy storage products during the off-peak period and a total discharging capacity of the target investment quantity of energy storage products during a peak period based on the load data of the electricity consumption side and the usage performance data; obtaining a charging cost based on the actual total charging capacity and a first electricity price during the off-peak period; obtaining a discharging revenue based on the total discharging capacity and a second electricity price during the peak period; and determining the energy storage revenue result of the target investment quantity of energy storage products based on the charging cost and the discharging revenue.

In some embodiments, the load data of the electricity consumption side at least includes a transformer capacity of the electricity consumption side and an actual load value of the electricity consumption side. The usage performance data at least includes a rated capacity of an individual energy storage product and a current residual electricity capacity of each energy storage product. The determining the actual total charging capacity of the target investment quantity of energy storage products during the off-peak period includes: determining a required charging capacity for the target investment quantity of energy storage products based on the current residual electricity capacity and the rated capacity; determining an available charging capacity for the target investment quantity of energy storage products based on the transformer capacity and the actual load value; and determining the actual total charging capacity based on the required charging capacity and the available charging capacity.

In some embodiments, the determining the actual total charging capacity based on the required charging capacity and the available charging capacity includes: determining, if the required charging capacity is less than or equal to the available charging capacity, the required charging capacity to be the actual total charging capacity; and determining, if the required charging capacity is greater than the available charging capacity, the available charging capacity to be the actual total charging capacity.

In some embodiments, the load data of the electricity consumption side includes at least a second electricity load of the electricity consumption side during a super-peak period. The usage performance data includes at least a current residual electricity capacity of the target investment quantity of energy storage products that is stored during the off-peak period. The peak period includes an on-peak period and a super-peak period. The determining the total discharging capacity of the target investment quantity of energy storage products during the peak period includes: determining a first total discharging capacity of the target investment quantity of energy storage products during the super-peak period based on the second electricity load; and determining a second total discharging capacity of the target investment quantity of energy storage products during the on-peak period based on the current residual electricity capacity and the first total discharging capacity.

In some embodiments, the second electricity price includes an electricity price during the super-peak period and an electricity price during the on-peak period. The obtaining the discharging revenue based on the total discharging capacity and the second electricity price during the peak period includes obtaining the discharging revenue based on the first total discharging capacity, the second total discharging capacity, the electricity price during the super-peak period and the electricity price during the on-peak period.

In some embodiments, the energy storage revenue result includes at least one or more of an annual total charging capacity, an annual total discharging capacity, an annual total charging cost, and an annual total discharging revenue. The determining the energy storage revenue result of the target investment quantity of energy storage products based on the charging cost and the discharging revenue includes: periodically determining the charging cost and the discharging revenue with a second preset duration as a cycle; obtaining the annual total charging cost for the target investment quantity of energy storage products by accumulating the charging cost determined in each cycle; and obtaining the annual total discharging revenue for the target investment quantity of energy storage products by accumulating the discharging revenue determined in each cycle.

In some embodiments, the energy storage revenue result further includes an annual net profit. The method further includes: obtaining a product maintenance fees and a product-incurred taxes for the target investment quantity of energy storage products; and obtaining the annual net profit of the target investment quantity of energy storage products based on the product maintenance fees, the product-incurred taxes, the annual total charging cost and the annual total discharging revenue.

In some embodiments, the method for determining the energy storage revenue further includes: determining a degradation rate of the energy storage product; periodically determining the actual total charging capacity and the total discharging capacity with the second preset duration as a cycle; obtaining the annual total charging capacity by accumulating an actual charging capacity determined in each cycle; obtaining the annual total discharging capacity by accumulating a discharging capacity determined in each cycle; and determining, based on the degradation rate, future energy storage development data for the target investment quantity of energy storage products according to the annual total charging capacity, the annual total discharging capacity, and/or the energy storage revenue result, wherein the future energy storage development data includes a future annual total charging capacity, a future annual total discharging capacity, a future annual total charging cost, and/or a future annual total discharging revenue.

In some embodiments, the method for determining the energy storage revenue further includes determining an energy storage economic indicator of the target investment quantity of energy storage products based on the energy storage revenue result and the usage performance data, the energy storage economic indicator including one or more of a net present value, a payback period, and an internal rate of return.

In some embodiments, the method for determining the energy storage revenue further includes generating a visual data report based on the energy storage revenue result, the annual net profit, the future energy storage development data and/or the energy storage economic indicator.

An embodiment in a second aspect of the present disclosure provides an electronic device. The electronic device includes at least one processor and a memory communicatively connected to the at least one processor. The memory stores a computer program executable by the at least one processor. The computer program when executed by the at least one processor, implements the method for determining the energy storage revenue according to any of the above embodiments.

The electronic device according to the embodiment of the present disclosure, when executing the computer program by its processor, implements the method for determining the energy storage revenue described in any of the above embodiments. Using this method allows for precise calculation of the energy storage revenue result, thereby enhancing the investment accuracy and the investment return rate.

An embodiment in a third aspect of the present disclosure provides a non-transitory computer storage medium, on which a computer program is stored. The computer program when executed by a processor, implements the method for determining the energy storage revenue according to any of the above embodiments.

The non-transitory computer storage medium according to the embodiment of the present disclosure stores the computer program that, when executed by a processor, implements the method for determining the energy storage revenue described in any of the above embodiments. By using the method, the non-transitory computer storage medium enables precise calculation of the energy storage revenue result, thereby enhancing the investment accuracy and the investment return rate.

The additional aspects and advantages of the present disclosure will be partially presented in the following description, partially become apparent from the description below, or be understood through the practice of the present disclosure.

### BRIEF DESCRIPTION OF THE DRAWINGS

The above and/or additional aspects and advantages of the present disclosure become apparent and comprehensible from the description of embodiments in connection with accompanying drawings, in which:

FIG. 1 is a flowchart of a method for determining energy storage revenue according to an embodiment of the present disclosure; and

FIG. 2 is a flowchart showing collecting and cleaning load data on an electricity consumption side according to an embodiment of the present disclosure.

### DETAILED DESCRIPTION

Embodiments of the present disclosure will be described below in details. The embodiments described with reference to the accompanying drawings are exemplary.

To solve the above problems, an embodiment in a first aspect of the present disclosure provides a method for determining energy storage revenue. The method enables precise calculation of energy storage revenue results, thereby enhancing the accuracy and the return rate of the investment.

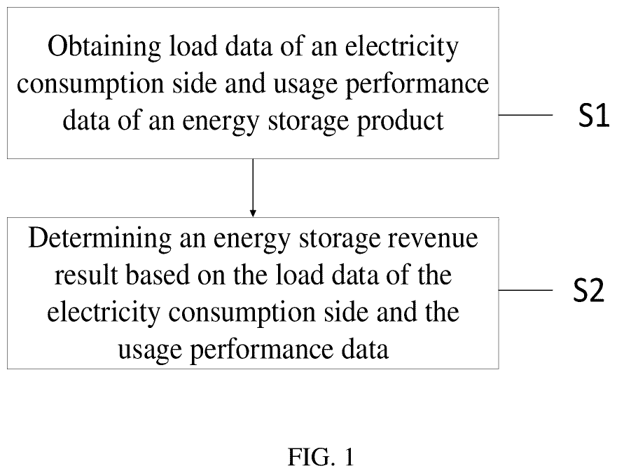

With reference to FIG. 1, a method for determining energy storage revenue in accordance with an embodiment of the present disclosure is described below. As shown in FIG. 1, the method includes steps S1 to S2.

At step S1, load data of an electricity consumption side and usage performance data of an energy storage product are obtained.

Herein, the electricity consumption side refers to a side where power consumers are located, and is responsible for the consumption and metering of electricity. The load data of the electricity consumption side reflects the use conditions of the electrical power demand during operation of the load of the electricity consumption side, such as electricity consumption data, consumption periods, and electricity prices. The usage performance data for an energy storage product serves as a crucial basis for evaluating applicability and economic feasibility of the energy storage product. The usage performance data can include rated capacity, rated power, charge/discharge efficiency, depth of charge/discharge, Engineering, Procurement and Construction (EPC) unit price, and operations and maintenance unit price.

Specifically, the load data of the electricity consumption side and the usage performance data of an energy storage product can be acquired either by manually inputting known data or by networking, with no restrictions imposed on the acquisition methods.

Furthermore, considering that the acquired load data of the electricity consumption side may contain some invalid or anomalous data, the present disclosure will perform data cleansing on the load data of the electricity consumption side to ensure its accuracy and validity, that is, removing dirty data and invalid data, thereby guaranteeing the accuracy and reliability of subsequent calculations of the energy storage revenue.

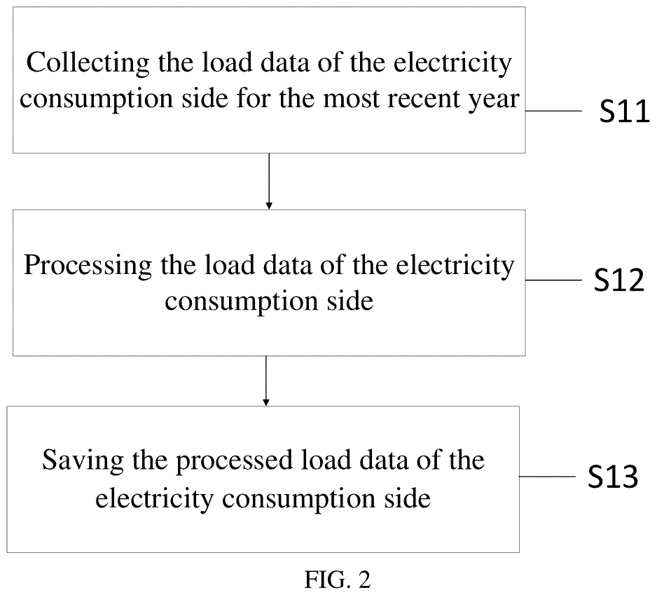

An exemplary illustration of the cleaning process of the load data of the electricity consumption side is provided below. The specific process, as shown in FIG. 2, includes at least steps S11 to S13.

At step S11, the load data of the electricity consumption side for the most recent year is collected. The load data of the electricity consumption side for the most recent year may refer to accumulated data that is obtained by data acquisition at intervals of 15, 30 or 60 minutes throughout each day of that year.

At step S12, the load data of the electricity consumption side is processed. The specific processing method can include: excluding, from all the load data of the electricity consumption side, load data of the electricity consumption side that is significantly too large or significantly too small; and filtering out load data of the electricity consumption side for each day that fails to meet the minimum load ratio; performing, after the above two data processing steps, data completion for the remaining qualified load data of the electricity consumption side, i.e., filling in the data corresponding to missing time points, the data completion rule involving using the median of all load data of the electricity consumption side at a current time period of that day as the data at the missing time points in the current time period of that day; and associating each load data of the electricity consumption side with its corresponding time period tier and the electricity price in the corresponding time period tier.

At step S13, the processed load data of the electricity consumption side is saved.

By implementing the above steps, the cleaning of load data of the electricity consumption side is achieved, thereby effectively enhancing the reliability of the obtained load data of the electricity consumption side and improving the accuracy of calculations for energy storage revenue results.

At step S2, the energy storage revenue result is determined based on the load data of the electricity consumption side and the usage performance data.

The energy storage revenue result represents the economic benefits achievable under specific load data of the electricity consumption side and specific usage performance data. The result can be used to analyze and evaluate whether the conditions present a worthwhile investment.

It is understandable that an energy storage product generates energy storage revenue by charging during periods of low electricity prices and discharging during periods of high electricity prices. Based on this principle, the present disclosure can precisely determine the energy storage revenue result of the energy storage product by collecting actual load data of the electricity consumption side and combining it with the usage performance data of the energy storage product itself. Consequently, compared to existing technologies that rely solely on empirical values to estimate energy storage revenue, the present disclosure employs a method that combines actual load data from the electricity consumption side with the usage performance data of the energy storage product for analysis and calculation, and enables precise calculation of the energy storage revenue result, thereby providing investors with timely and effective data support to enhance the investment accuracy and the investment return rate.

The method for determining energy storage revenue according to the embodiments of the present disclosure combines actual load data of the electricity consumption side with usage performance data of an energy storage product for analysis and calculation, and thus enables the computation of the energy storage revenue result for different energy storage products, thereby providing investors with timely and effective data support to enhance the investment accuracy and the investment return rate. Meanwhile, compared to traditional methods that estimate energy storage revenue based on empirical data, the present disclosure calculates the energy storage revenue result using a combination of actual load data of the electricity consumption side as a basis and the usage performance data of the energy storage product, and can effectively ensure the accuracy and practicality of the calculated result, significantly improving the accuracy of investment forecasts, and reduces investment risks.

In some embodiments, the determining the energy storage revenue result based on the load data of the electricity consumption side and the usage performance data includes: determining a target investment quantity of energy storage products based on the load data of the electricity consumption side; and determining the energy storage revenue result for the target investment quantity of energy storage products based on the load data of the electricity consumption side and the usage performance data.

Specifically, since the energy storage revenue result varies based on different quantities of energy storage products invested, the present disclosure should first consider the investment quantity of energy storage products when determining the energy storage revenue result. Specifically, the target investment quantity of energy storage products is determined based on actual load data of the electricity consumption side. That is, by analyzing and calculating the collected load data of the electricity consumption side to scientifically and reasonably estimate the target investment quantity for the energy storage products, it can ensure that the target investment quantity of energy storage products can both meet electricity consumption demand during peak periods and enable effective charging during off-peak periods, thereby maximizing investment revenue. Furthermore, the energy storage revenue result for the target investment quantity of energy storage products are determined based on load data of the electricity consumption side and the usage performance data, thereby providing investors with comprehensive investment details and data support and enhancing the accuracy of investment forecasts.

In some embodiments, the load data of the electricity consumption side at least includes a first electricity load of the electricity consumption side during an off-peak period and a second electricity load of the electricity consumption side during a super-peak period. The determining the target investment quantity of the energy storage products based on the load data of the electricity consumption side includes: acquiring the first electricity load and the second electricity load periodically with a first preset duration as a cycle; determining a first available charging capacity periodically based on a transformer capacity and the first electricity load; accumulating the first available charging capacity determined in each cycle to obtain a total charging capacity at the electricity consumption side during the off-peak period; accumulating the second electricity load determined in each cycle to obtain a required total discharging capacity of the electricity consumption side during the super-peak period; and determining the target investment quantity based on the total charging capacity and the required total discharging capacity.

The first preset duration refers to the time interval (i.e., a cycle) for collecting load data of the electricity consumption side, i.e., a frequency at which the load data of the electricity consumption side is collected. The first preset duration can be set according to actual conditions and is not subject to restrictions. For example, the first preset duration can be 15 minutes, 30 minutes, or 60 minutes. That is, the load data of the electricity consumption side can be collected at 15-minute intervals, 30-minute intervals, or 60-minute intervals.

It is understood that the off-peak period refer to a time period of a day when electricity load is relatively low. During the off-peak period, a plurality of first electricity loads can be collected with the first preset duration as a cycle. Similarly, the super-peak period refer to a time period of a day when the electricity load reaches its peak. During the super-peak period, a plurality of second electricity loads can be collected with the first preset duration as a cycle.

Based on the above contents, when determining the target investment quantity of the energy storage products, this solution in the present disclosure operates as follows. During the off-peak period, the first electricity load is obtained at intervals of the first preset duration. Within each cycle, the obtained first electricity load and the transformer capacity are calculated to determine the first available charging capacity corresponding to that cycle. By periodically obtaining the first electricity load and calculating the first available charging capacity in this manner, the first chargeable capacities corresponding to respective cycles during the off-peak period are ultimately summed to obtain the total charging capacity of the electricity consumption side. Similarly, during the super-peak period, the second electricity load is acquired at intervals of the first preset duration. Ultimately, the second electricity loads corresponding to respective cycles during the super-peak period are summed to obtain the required total discharging capacity of the electricity consumption side. Furthermore, based on the total charging capacity and the required total discharging capacity as calculated above, a reasonable target investment quantity is determined. This ensures that the discharge demand during the super-peak period can be met and effective charging during the off-peak period can be achieved. Consequently, the subsequent calculation of the energy storage revenue result for the target investment quantity of energy storage products is rationalized, enabling optimal operation of the energy storage system and maximization of investment returns.

In some embodiments, the formula for determining the first available charging capacity based on the transformer capacity and the first electricity load can be: the first available charging capacity=the transformer capacity−the first electricity load.

In some embodiments, to achieve the dual objectives of meeting the discharge demand in the super-peak period and enabling efficient charging during the off-peak period, the optimal target investment quantity can be determined by comprehensively considering the required investment quantity for the off-peak period and the required investment quantity for the super-peak period. Specifically, the number of energy storage products required during the off-peak period, i.e., a first quantity value, is determined based on the total charging capacity and a rated capacity of each energy storage product. The number of energy storage products required during the super-peak period, i.e., a second quantity value, is determined based on the required total discharging capacity and the rated capacity of each energy storage product. Subsequently, the target investment quantity is determined based on the first and second quantity values, thereby maximizing the energy storage investment return.

For example, the first quantity value that is determined based on the total charging capacity and the rated capacity of a single energy storage product can be calculated using the following formula: the first quantity value=the total charging capacity/the rated capacity of a single energy storage product. Additionally, the second quantity value that is determined based on the required total discharging capacity and the rated capacity of a single energy storage product can be calculated using the following formula: the second quantity value=the required total discharging capacity/the rated capacity of a single energy storage product. Furthermore, the target investment quantity is determined by comparing the first quantity value and the second quantity value, thereby ensuring that the energy storage product achieves an optimal balance between investment costs and operational benefits while meeting charging and discharging requirements.

In some embodiments, the determining the target investment quantity based on the first quantity value and the second quantity value includes: determining the target investment quantity based on a minimum value between the first quantity value and the second quantity value.

Specifically, if the target investment quantity exceeds the quantity demand for either the off-peak or super-peak period, the redundant energy storage products will not be fully utilized during that period, thereby reducing investment returns. Therefore, to maximize the return on energy storage investments, the present disclosure determines the final target investment quantity based on the smaller one of the required number of energy storage products in the two periods.

For example, in some embodiments, by comparing the magnitudes of the first quantity value and the second quantity value, the smaller one of the two values may be selected directly as the target investment quantity. That is, if the first quantity value is less than the second quantity value, the first quantity value can be used as the target investment quantity. Conversely, if the first quantity value is greater than the second quantity value, the second quantity value can be used as the target investment quantity. It can be understood that when the first quantity value equals the second quantity value, the target investment quantity=the first quantity value=the second quantity value. Subsequently, the energy storage revenue result is calculated based on the target investment quantity determined as described above.

Alternatively, in some embodiments of the present disclosure, considering the practical application scenarios of energy storage products such as the charging/discharging efficiency and the cycle life, a target investment quantity can be established as the center to define a investment quantity range. Specifically, the investment quantity range is defined as follows: a first investment quantity≤the target investment quantity≤a second investment quantity, where the first investment quantity=a minimum value−a preset value, and the second investment quantity=the minimum value+the preset value. Subsequently, different target investment quantities are selected within the range for further calculations to obtain energy storage benefit results under different target investment quantities. Thus, based on maximizing the energy storage revenue with the target investment quantity of energy storage products, this approach not only provides the investors with the energy storage revenue result for the target investment quantity of energy storage products, but also provides the investors with the corresponding energy storage revenue results for scenarios with slight fluctuations in the number of energy storage products. For the investors, this enhances data support for energy storage revenue under different quantities and expands the scope for investment consideration, thereby improving investment accuracy and return rates.

The preset value can be set according to the practical application scenarios of energy storage products, and no specific limitation is imposed herein. For example, assuming a minimum value of 10, the preset value can be set to 2, resulting in a first investment quantity of 8 and a second investment quantity of 12, i.e., an investment quantity range of 8 to 12. Consequently, any value in the investment quantity range can be selected as the target investment quantity, such as 8, 9, or 12. Subsequently, the energy storage revenue result for 8 energy storage products can be determined based on the load data of the electricity consumption side and the usage performance data, and/or the energy storage revenue result for 9 energy storage products can be determined based on the load data of the electricity consumption side and the usage performance data, and/or the energy storage revenue result for 12 energy storage products can be determined based on the load data of the electricity consumption side and the usage performance data, and so on. Alternatively, the preset value can be set to 1, resulting in a first investment quantity of 9 and a second investment quantity of 11, i.e., an investment quantity range of 9 to 11. Accordingly, any value within this investment quantity range can be selected as the target investment quantity, such as 9, 10, or 11. Subsequently, the energy storage revenue result for 9 energy storage products can be determined based on the load data of the electricity consumption side and the usage performance data, and/or the energy storage revenue result for 10 energy storage products can be determined based on the load data of the electricity consumption side and the usage performance data, and/or the energy storage revenue result for 11 energy storage products can be determined based on the load data of the electricity consumption side and the usage performance data.

In some embodiments, the determining the energy storage revenue result for the target investment quantity of energy storage products based on the load data of the electricity consumption side and the usage performance data includes: determining an actual total charging capacity of the target investment quantity of energy storage products during the off-peak period and a total discharging capacity of the target investment quantity of energy storage products during a peak period based on the load data of the electricity consumption side and the usage performance data; obtaining a charging cost based on the actual total charging capacity and a first electricity price during the off-peak period; obtaining a discharging revenue based on the total discharging capacity and a second electricity price during the peak period; and determining the energy storage revenue result of the target investment quantity of energy storage products based on the charging cost and the discharging revenue.

Therefore, after determining the target investment quantity for the energy storage products, the present disclosure accurately calculates the charging capacities and the charging costs during off-peak periods, as well as the discharging capacities and the discharging revenues during peak periods by using the load data of the electricity consumption side and the usage performance data, so as to comprehensively determine the energy storage revenue result, thereby providing data support for the economic evaluation and investment decisions of the energy storage system.

Specifically, based on the load data of the electricity consumption side and the usage performance data, the actual total charging capacity of the target investment quantity of energy storage products during the off-peak period and the total discharging capacity of the target investment quantity of energy storage products during the peak period can be determined. Subsequently, the actual total charging capacity is multiplied by the first electricity price during the off-peak period to obtain the charging cost, and the total discharging capacity is multiplied by the second electricity price during the peak period to obtain the discharging revenue. Furthermore, the energy storage revenue result for the target investment quantity of energy storage products can be determined based on the charging cost and the discharging revenue. This enables a comprehensive evaluation of the operational benefits of the energy storage system and provides a scientific basis for estimating the return on energy storage investments..

In some embodiments, the load data of the electricity consumption side at least includes a transformer capacity of the electricity consumption side and an actual load value of the electricity consumption side. The usage performance data at least includes a rated capacity of an individual energy storage product and a current residual electricity capacity of each energy storage product. The determining the actual total charging capacity of the target investment quantity of energy storage products during the off-peak period includes: determining a required charging capacity for the target investment quantity of energy storage products based on the current residual electricity capacity and the rated capacity; determining an available charging capacity for the target investment quantity of energy storage products based on the transformer capacity and the actual load value; and determining the actual total charging capacity based on the required charging capacity and the available charging capacity.

Specifically, based on the current residual electricity capacity and the rated capacity of each energy storage product, the required charging capacity for each product can be calculated using the following formula: the required charging capacity of each energy storage product=the rated capacity of each energy storage product−the current residual electricity capacity of each energy storage product. Subsequently, the required charging capacity for the target investment quantity of energy storage products is obtained by summing the required charging capacities of respective energy storage products. Additionally, based on the transformer capacity and the actual load value, the available charging capacity of the target investment quantity of energy storage products can be calculated using the following formula: the available charging capacity=the transformer capacity−the actual load value. Furthermore, by comparing the required charging capacity with the available charging capacity, the actual total charging capacity of the target investment quantity of energy storage products is determined.

In some embodiments, the determining the actual total charging capacity based on the required charging capacity and the available charging capacity includes: determining, if the required charging capacity is less than or equal to the available charging capacity, the required charging capacity to be the actual total charging capacity; and determining, if the required charging capacity is greater than the available charging capacity, the available charging capacity to be the actual total charging capacity.

During the off-peak period, the charging capacity of the energy storage product depends on two factors, i.e., a first factor which is the required charging capacity of the energy storage product itself, in other words, the difference between the rated capacity and the current residual electricity capacity of the energy storage product, and a second factor which is the available charging capacity provided by the difference between the transformer capacity and the actual load value of the electricity consumption side. Subsequently, the actual total charging capacity is determined by comparing the required charging capacity with the available charging capacity, and the charging fee is calculated based on the actual total charging capacity. Specifically, if the required charging capacity is less than or equal to the available charging capacity, it indicates that the target investment quantity of energy storage products can be fully charged. In the case, the actual total charging capacity equals the required charging capacity. If the required charging is greater than the available charging capacity, it indicates that the target investment quantity of energy storage products cannot be fully charged. In the case, the actual total charging capacity is equal to the available charging capacity. Furthermore, by multiplying the actual total charging capacity by the first electricity rate during the off-peak period, the charging cost for the off-peak period can be calculated.

In some embodiments, the load data of the electricity consumption side includes at least a second electricity load of the electricity consumption side during a super-peak period. The usage performance data includes at least a current residual electricity capacity of the target investment quantity of energy storage products that is stored during the off-peak period. The peak period includes an on-peak period and a super-peak period. the determining the total discharging capacity of the target investment quantity of energy storage products during the peak period includes: determining a first total discharging capacity of the target investment quantity of energy storage products during the super-peak period based on the second electricity load; and determining a second total discharging capacity of the target investment quantity of energy storage products during the on-peak period based on the current residual electricity capacity and the first total discharging capacity.

Specifically, considering that the discharging revenue of the energy storage product during the super-peak period is superior to the discharging revenue of the energy storage product during the on-peak period, in the present disclosure, the discharging behavior of the energy storage product is adjusted based on the above circumstances when calculating the discharging revenue. In other words, when the energy storage product discharges electricity, the electricity demand during the super-peak period takes precedence over the electricity demand during the on-peak period. Specifically, before entering the on-peak period, it is detected whether the upcoming period is a super-peak period. If the next time period is the super-peak period, the first total discharging capacity of the target investment quantity of energy storage products during the super-peak period is determined based on the second electricity load, and a current residual electricity capacity of the energy storage products is updated. If the target investment quantity of energy storage products still has residual electricity after discharging during the super-peak period, they will continue discharging during the on-peak period. The discharging capacity at this point is equal to the current residual electricity capacity of the target investment quantity of energy storage products after the discharging during the super-peak period. Based on a current residual electricity capacity stored by the target investment quantity of energy storage products during the off-peak period and the first total discharging capacity, the second total discharging capacity of the target investment quantity of energy storage products during the on-peak period can be determined using the following formula: the second total discharging capacity=the current residual electricity capacity stored during the off-peak period−the first total discharging capacity. The second total discharging capacity can also be understood as the residual electricity capacity of the target investment quantity of energy storage products after discharging during the super-peak period. Conversely, if the energy storage product has no residual electricity after discharging during the super-peak period, it will not discharge during the on-peak period.

Additionally, after the super-peak period, the target investment quantity of energy storage products discharge electricity based on the second electricity load during the super-peak period. The discharging capacity needs to meet the electricity demand of the second electricity load, but does not exceed the current residual electricity capacity of the target investment quantity of energy storage products. It is understood that the target investment quantity of energy storage products must have their current residual electricity capacity updated after completing discharge.

In some embodiments, the second electricity price includes an electricity price during the super-peak period and an electricity price during the on-peak period. The obtaining the discharging revenue based on the total discharging capacity and the second electricity price during the peak period includes obtaining the discharging revenue based on the first total discharging capacity, the second total discharging capacity, the electricity price during the super-peak period and the electricity price during the on-peak period.

Specifically, multiplying the first total discharging capacity by the electricity price during the super-peak period yields the first discharging revenue during the super-peak period, and multiplying the second total discharging capacity by the electricity price during the on-peak period yields the second discharging revenue during the on-peak period. The discharging revenue for the target investment quantity of energy storage products can be obtained by summing the first discharging revenue and the second discharging revenue.

Based on the above, utilizing detailed load data of the electricity consumption side to accurately calculate the actual total charging capacity and the charging cost during the off-peak period, as well as the total discharging capacity and the discharging revenue during peak period, so as to provide data support for the economic evaluation and investment decisions of the energy storage system.

In some embodiments, the energy storage revenue result includes an annual total charging cost and an annual total discharging revenue. The determining the energy storage revenue result of the target investment quantity of energy storage products based on the charging cost and the discharging revenue includes: periodically determining the charging cost and the discharging revenue with a second preset duration as a cycle; obtaining the annual total charging cost for the target investment quantity of energy storage products by accumulating the charging cost determined in each cycle; and obtaining the annual total discharging revenue for the target investment quantity of energy storage products by accumulating the discharging revenue determined in each cycle.

The second preset duration refers to a frequency at which the charging cost and the discharging revenue are calculated, and its specific time length can be set according to actual conditions, with no restrictions imposed. For example, the second preset duration can be 15 minutes, 30 minutes, or 60 minutes. That is, the charging cost and the discharging revenue can be calculated at intervals of 15 minutes, 30 minutes, or 60 minutes. Additionally, in the present disclosure, the first preset duration and the second preset duration are set to the same value or to different values as required, with no restrictions imposed.

Specifically, the charging cost and the discharging revenue are calculated at intervals of the second preset duration. After periodically obtaining and aggregating all calculated charging costs and discharging revenues for the target investment quantity of energy storage products over the past year, the annual total charging cost is derived by summing all the charging costs, and the annual total discharging revenue is derived by summing all the discharging revenues. Thus, the annual total charging cost and annual total discharging revenue provide data support for the economic evaluation and investment decisions of the energy storage system.

In some embodiments, the energy storage revenue result further includes an annual net profit. The method further includes: obtaining product maintenance fees and product-incurred taxes for the target investment quantity of energy storage products; and obtaining the annual net profit of the target investment quantity of energy storage products based on the product maintenance fees, the product-incurred taxes, the annual total charging cost and the annual total discharging revenue.

The product-incurred taxes include at least a payable value-added tax, taxes and surcharges, and a corporate income tax.

Specifically, for the energy storage revenue of the target investment quantity of energy storage products, the income is the annual total discharging revenue, and the expenditures include the product maintenance fees, the product-incurred taxes, and the annual total charging cost. Based on the, the annual net profit is the result of the income minus the expenditures. That is to say, the annual net profit=the annual total discharging revenue−the annual total charging cost−the product maintenance fees-the product-incurred taxes.

In some embodiments, the method for determining the energy storage revenue further includes: determining a degradation rate of the energy storage product; periodically determining the actual total charging capacity and the total discharging capacity with the second preset duration as a cycle; obtaining the annual total charging capacity by accumulating an actual charging capacity determined in each cycle; obtaining the annual total discharging capacity by accumulating a discharging capacity determined in each cycle; and determining, based on the degradation rate, future energy storage development data for the target investment quantity of energy storage products according to the annual total charging capacity, the annual total discharging capacity, and/or the energy storage revenue result where the future energy storage development data includes a future annual total charging capacity, a future annual total discharging capacity, a future annual total charging cost, and/or a future annual total discharging revenue.

Specifically, as the usage time of the energy storage product increases, its capacity and performance will gradually degrade. The degradation rate of the energy storage product is a key indicator for assessing the decline extent of the performance of the energy storage product, and significantly affects the performance and the lifespan of the energy storage product in practical applications. Therefore, in order to understand the development of the energy storage product over future years, the degradation rate of the energy storage product is of great significance for obtaining the future energy storage development data. Based on this, in the present disclosure, the actual total charging capacity and the total discharging capacity are calculated at intervals of the second preset duration. After periodically obtaining and aggregating all calculated actual total charging capacities and total discharging capacities for the target investment quantity of energy storage products over the past year, the annual total charging capacity is derived by summing all actual total charging capacities, and the annual total discharging capacity is derived by summing all total discharging capacities. Subsequently, based on the degradation rate, the future energy storage development data for the target investment quantity of energy storage products is determined according to the annual total charging capacity, annual total discharging capacity, and/or the energy storage revenue result.

In some embodiments, the future energy storage development data can be obtained using the following formulas: the future annual total charging capacity=the annual total charging capacity over the past year×the degradation rate, the future annual total charging capacity=the annual total discharging capacity over the past year×the degradation rate, the future annual total charging cost=the annual total charging costs over the past year×the degradation rate, and the future annual total discharging revenue=the annual total discharging revenue over the past year×the degradation rate. It is understood that the above calculation method for the future energy storage development data is merely one example. Based on the same principle, other calculation methods can also be used to obtain the future energy storage development data, and no restrictions are imposed in the regard.

For example, taking the future energy storage development data as the development data for energy storage products over the next 2 to 10 years, and combining the annual total charging capacity, the annual total discharging capacity, and/or the energy storage revenue result of the target investment quantity of energy storage products aggregated in the first year, the annual total charging capacity, the annual total discharging capacity, and/or the energy storage revenue result are adjusted year by year based on the degradation rate of the energy storage product to obtain the future energy storage development data.. For example, the annual total charging capacity for the target investment quantity of energy storage products in the second year in the future is equal to a value obtained by multiplying the annual total charging capacity in the first year by the degradation rate. The annual total charging capacity for the target investment quantity of energy storage products in the third year in the future is equal to a value obtained by multiplying the annual total charging capacity in the second year by the degradation rate. The annual total charging capacity for the target investment quantity of energy storage products in the fourth year in the future is equal to a value obtained by multiplying the annual total charging capacity in the third year by the degradation rate, and so on. In this way, the annual total charging capacity for the target investment quantity of energy storage products for each year in the future can be obtained. Similarly, the future annual total charging capacity, the future annual total charging cost, and the future annual total discharging revenue for the target investment quantity of energy storage products can be obtained in the same manner. By aggregating the future energy storage development data for each year, charging and discharging cash flows for the target investment quantity of energy storage products in the first ten years are formed. This provides decision-makers with a more comprehensive and systematic understanding of the energy storage economic situation, thereby offering stronger data support for understanding and comparing the economics of different energy storage products.

In some embodiments, the method for determining the energy storage revenue further includes determining an energy storage economic indicator of the target investment quantity of energy storage products based on the energy storage revenue result and the usage performance data, the energy storage economic indicator including one or more of a net present value, a payback period, and an internal rate of return.

The energy storage economic indicator can be used to assess the economic feasibility and investment value of an energy storage project. The net present value (NPV) represents a sum of the present values of net revenues of the energy storage products that are calculated after taking into account the time value of money of the energy storage products. The payback period refers to the time period required from the start of operation of the energy storage products until the full recovery of the initial investment. The internal rate of return reflects the profitability and investment efficiency of the energy storage products themselves. Consequently, by utilizing these diverse energy storage economic indicators, the present disclosure can provide investors with additional data references and offer a scientific basis for investment decisions and optimized operation of the energy storage project.

Exemplarily speaking, in simple terms, the energy storage economic indicator is calculated based on the initial investment cost and cash flows over the first ten years. For instance, the initial investment cost includes the EPC unit price, operation and maintenance unit price, the product maintenance fees, and the product-incurred taxes. The cash flows over the first ten years include the annual total charging fees in the first year, the annual total discharging revenue in the first year, future annual total charging fees, and future annual total discharging revenues. By applying industry-standard calculation methods, the energy storage economic indicator for the energy storage products can be determined.

In some embodiments, the method for determining the energy storage revenue further includes generating a visual data report based on the energy storage revenue result, the annual net profit, the future energy storage development data and/or the energy storage economic indicator.

Therefore, the present disclosure visualizes the energy storage revenue result, the annual net profit, the future energy storage development data, and/or the energy storage economic indicator, thereby enabling investors to gain a more intuitive understanding of the profitability of energy storage products and enhancing decision-making efficiency.

For example, visual data reports may include a summary table of financial indicators for the energy storage products, an annual charge/discharge capacity table for the energy storage product, an annual tax and a profit table for the energy storage products. The summary table of financial indicators for the energy storage products can include a product name and quantity of the energy storage products, an initial investment amount for the energy storage products, an average annual charge/discharge capacity of the energy storage products over 10 years, a total charge/discharging revenue of the energy storage products over 10 years, a total maintenance cost of the energy storage products over 10 years, a residual asset value of the energy storage products after 10 years, a payback period for the energy storage products, an internal rate of return for the energy storage products. The annual charge/discharge capacity table for the energy storage products may include an annual charge/discharge capacity of the energy storage products for each year, an annual charging cost of the energy storage products for each year, an annual discharging revenue of the energy storage products for each year. The annual tax and a profit table may include the product-incurred taxes, the product maintenance fees, the charging fees, a discharging revenue and the net profit of the energy storage products for each year. Thus, through the above visual data reports, comprehensive and systematic economic calculation results can be provided to decision-makers. This facilitates the comparison of the economic viability of different energy storage products and provides strong support for investment decisions.

In some embodiments, the visual data report is presented in the form of an Excel sheet or an online chart, with no restrictions imposed. Additionally, visual data report may support export functionality to facilitate dissemination and usage.

In summary, the method for determining the energy storage revenue proposed in the present disclosure can both determine the economic returns of different types of energy storage products and determine the economic returns of the same type of energy storage products under varying target investment quantities. This enables investors to more comprehensively evaluate the investment potential of different energy storage products. Additionally, by generating multiple investment plans for diverse energy storage products and comparing their returns, it provides decision-makers with diversified investment options and comprehensive decision support. Meanwhile, through multi-dimensional comparisons of energy storage economic indicators, it offers investors holistic decision support, effectively optimizes the allocation of investment resources, helps investors to quickly select the optimal investment plan, and provides early warnings of potential investment risks to the investors, thereby significantly improving the accuracy and success rate of investment decisions. Furthermore, the method for determining the energy storage revenue according to the present disclosure can be widely applied to investment calculations for different types of energy storage products, thereby facilitating the promotion of the energy storage products. At the same time, the approach outlined herein—which involves in-depth analysis and calculation based on the load data of the electricity consumption side and the usage performance data of the energy storage product—can also reduce energy waste, lower carbon footprints, and advance the green transformation and sustainable development of energy structures.

An embodiment of a second aspect of the present disclosure provides an electronic device. The electronic device includes at least one processor and a memory communicatively connected to the at least one processor. The memory stores a computer program executable by the at least one processor. The computer program when executed by the at least one processor, implements the method for determining the energy storage revenue according to any of the above embodiments.

The electronic device according to the embodiment of the present disclosure, when executing the computer program by its processor, implements the method for determining the energy storage revenue described in any of the above embodiments. Using this method allows for precise calculation of the energy storage revenue result, thereby enhancing the investment accuracy and the investment return rate.

An embodiment of a third aspect of the present disclosure provides a non-transitory computer storage medium, on which a computer program is stored. The computer program when executed by a processor, implements the method for determining the energy storage revenue according to any of the above embodiments.

The non-transitory computer storage medium according to the embodiment of the present disclosure stores the computer program that, when executed by a processor, implements the method for determining the energy storage revenue described in any of the above embodiments. By using the method, the non-transitory computer storage medium enables precise calculation of the energy storage revenue result, thereby enhancing the investment accuracy and the investment return rate.

In the description of this disclosure, any process or method description shown in a flowchart or described in other ways herein can be understood to mean that it includes one or more modules, fragments, or parts of codes of executable instructions for implementing customized logic functions or steps of the process. The scope of the preferred embodiments of the present disclosure includes additional implementations which may not perform functions in the order shown or discussed, including a substantially simultaneous manner or in the reverse order according to involved functions, which should be understood by those skilled in the art to which the embodiments of the present disclosure belong.

The logic and/or steps represented in the flowchart or described in other ways herein, for example, can be considered as a sequenced list of executable instructions for implementing logic functions, and can be embodied in any computer-readable medium for use by an instruction execution system, device, or apparatus (such as a computer-based system, a system including a processor, or other system that can fetch and execute instructions from the instruction execution system, device, or apparatus), or for use in combination with the instruction execution system, device or apparatus. For the purposes of the description, a “computer-readable medium” can be any device that can contain, store, communicate, propagate, or transmit a program for use by an instruction execution system, device, or apparatus or for use in combination with the instruction execution system, device, or apparatus. More specific examples (non-exhaustive list) of the computer-readable medium include an electrical connection (electronic apparatus) with one or more wiring, a portable computer disk case (a magnetic device), a Random Access Memory (RAM), a Read-Only Memory (ROM), an Erasable and Programmable Read-Only Memory (EPROM or flash memory), a fiber optic device, and a portable Compact Disk Read-Only Memory (CDROM). In addition, the computer-readable medium may even be paper or other suitable medium on which the program can be printed, because for example the paper or the other medium can be optically scanned, and then be edited, interpreted, or processed in other suitable manner if necessary to obtain the program electronically and the program can be stored in a computer memory.

It should be understood that each part of the present disclosure can be implemented by hardware, software, firmware or a combination thereof. In the above embodiments, multiple steps or methods can be implemented by software or firmware stored in a memory and executed by a suitable instruction execution system. For example, if it is implemented by hardware as in another embodiment, it can be implemented by any one of or a combination of the following technologies well known in the art: discrete logic circuits having logic gate circuits for implementing logic functions on data signals, application specific integrated circuits with a suitable combination of logic gate circuits, a programmable gate array (PGA), a field programmable gate array (FPGA), etc.

A person of ordinary skill in the art can understand that all or part of the steps in the method of any of the foregoing embodiments can be completed by a program instructing relevant hardware. The program can be stored in a computer-readable storage medium. When the program is executed, it implements one of the steps or any combination thereof in the method in any of the embodiments.

In addition, the functional units in the various embodiments of the present disclosure may be integrated in one processing module, or each functional unit may exist alone physically, or two or more units may be integrated into one module. The above-mentioned integrated module can be implemented in the form of hardware or software functional module. If the integrated module is implemented in the form of a software function module and sold or used as an independent product, it can also be stored in a computer-readable storage medium.

The aforementioned storage medium may be a read-only memory, a magnetic disk or an optical disk, etc. Although the embodiments of the present disclosure have been shown and described above, it can be understood that the above-mentioned embodiments are exemplary and should not be construed as limiting the present disclosure. Those of ordinary skill in the art can make changes, modifications, substitutions, and variations to the above embodiments within the range of the present disclosure.

In the illustration of this description, an illustration with reference to the terms “one embodiment”, “some embodiments”, “illustrative embodiments”, “an example”, “a particular example” or “some examples” and so on mean that a particular feature, structure, material, or characteristic described in connection with the embodiment(s) or example(s) is included in at least one embodiment or example of the present disclosure. In this description, the exemplary expressions of the above terms do not necessarily specify the same embodiments or examples.

Although embodiments of the present disclosure have been shown and described, it will be understood by those skilled in the art that various changes, modifications, alternations and variations may be made to these embodiments without departing from the principles and spirit of the present disclosure, the scope of which is defined by the claims and their equivalents.

What is claimed is:

1. A method for determining energy storage revenue, comprising:
obtaining load data of an electricity consumption side and usage performance data of an energy storage product; and
determining an energy storage revenue result based on the load data of the electricity consumption side and the usage performance data.

2. The method for determining the energy storage revenue according to claim 1, wherein said determining the energy storage revenue result based on the load data of the electricity consumption side and the usage performance data comprises:
determining a target investment quantity of energy storage products based on the load data of the electricity consumption side; and
determining the energy storage revenue result for the target investment quantity of energy storage products based on the load data of the electricity consumption side and the usage performance data.

3. The method for determining the energy storage revenue according to claim 2, wherein the load data of the electricity consumption side at least comprises a first electricity load of the electricity consumption side during an off-peak period and a second electricity load of the electricity consumption side during a super-peak period, said determining the target investment quantity of the energy storage products based on the load data of the electricity consumption side comprises:
acquiring the first electricity load and the second electricity load periodically with a first preset duration as a cycle;
determining a first available charging capacity periodically based on a transformer capacity and the first electricity load;
accumulating the first available charging capacity determined in each cycle to obtain a total charging capacity at the electricity consumption side during the off-peak period;
accumulating the second electricity load determined in each cycle to obtain a required total discharging capacity of the electricity consumption side during the super-peak period; and
determining the target investment quantity based on the total charging capacity and the required total discharging capacity.

4. The method for determining the energy storage revenue according to claim 3, wherein said determining the target investment quantity based on the total charging capacity and the required total discharging capacity comprises:
determining a first quantity value based on the total charging capacity and a rated capacity of an individual energy storage product;
determining a second quantity value based on the required total discharging capacity and the rated capacity of the individual energy storage product; and
determining the target investment quantity based on the first quantity value and the second quantity value.

5. The method for determining the energy storage revenue according to claim 4, wherein said determining the target investment quantity based on the first quantity value and the second quantity value comprises:
determining the target investment quantity based on a minimum value between the first quantity value and the second quantity value.

6. The method for determining the energy storage revenue according to claim 5, wherein the target investment quantity satisfies: a first investment quantity≤the target investment quantity≤a second investment quantity, where the first investment quantity=the minimum value−a preset value, and the second investment quantity=the minimum value+the preset value.

7. The method for determining the energy storage revenue according to claim 2, wherein said determining the energy storage revenue result for the target investment quantity of energy storage products based on the load data of the electricity consumption side and the usage performance data comprises:
determining an actual total charging capacity of the target investment quantity of energy storage products during the off-peak period and a total discharging capacity of the target investment quantity of energy storage products during a peak period based on the load data of the electricity consumption side and the usage performance data;
obtaining a charging cost based on the actual total charging capacity and a first electricity price during the off-peak period;
obtaining a discharging revenue based on the total discharging capacity and a second electricity price during the peak period; and
determining the energy storage revenue result of the target investment quantity of energy storage products based on the charging cost and the discharging revenue.

8. The method for determining the energy storage revenue according to claim 7, wherein the load data of the electricity consumption side at least comprises a transformer capacity of the electricity consumption side and an actual load value of the electricity consumption side, the usage performance data at least comprises a rated capacity of an individual energy storage product and a current residual electricity capacity of each energy storage product, said determining the actual total charging capacity of the target investment quantity of energy storage products during the off-peak period comprises:
determining a required charging capacity for the target investment quantity of energy storage products based on the current residual electricity capacity and the rated capacity;
determining an available charging capacity for the target investment quantity of energy storage products based on the transformer capacity and the actual load value; and
determining the actual total charging capacity based on the required charging capacity and the available charging capacity.

9. The method for determining the energy storage revenue according to claim 8, wherein said determining the actual total charging capacity based on the required charging capacity and the available charging capacity comprises:
determining, if the required charging capacity is less than or equal to the available charging capacity, the required charging capacity to be the actual total charging capacity; and
determining, if the required charging capacity is greater than the available charging capacity, the available charging capacity to be the actual total charging capacity.

10. The method for determining the energy storage revenue according to claim 7, wherein the load data of the electricity consumption side comprises at least a second electricity load of the electricity consumption side during a super-peak period, the usage performance data comprises at least a current residual electricity capacity of the target investment quantity of energy storage products that is stored during the off-peak period, the peak period comprises an on-peak period and a super-peak period, said determining the total discharging capacity of the target investment quantity of energy storage products during the peak period comprises:
determining a first total discharging capacity of the target investment quantity of energy storage products during the super-peak period based on the second electricity load; and
determining a second total discharging capacity of the target investment quantity of energy storage products during the on-peak period based on the current residual electricity capacity and the first total discharging capacity.

11. The method for determining the energy storage revenue according to claim 10, wherein the second electricity price comprises an electricity price during the super-peak period and an electricity price during the on-peak period, said obtaining the discharging revenue based on the total discharging capacity and the second electricity price during the peak period comprises:
obtaining the discharging revenue based on the first total discharging capacity, the second total discharging capacity, the electricity price during the super-peak period and the electricity price during the on-peak period.

12. The method for determining the energy storage revenue according to claim 7, wherein the energy storage revenue result comprises an annual total charging cost and an annual total discharging revenue, said determining the energy storage revenue result of the target investment quantity of energy storage products based on the charging cost and the discharging revenue comprises:
periodically determining the charging cost and the discharging revenue with a second preset duration as a cycle;
obtaining the annual total charging cost for the target investment quantity of energy storage products by accumulating the charging cost determined in each cycle; and
obtaining the annual total discharging revenue for the target investment quantity of energy storage products by accumulating the discharging revenue determined in each cycle.

13. The method for determining the energy storage revenue according to claim 12, wherein the energy storage revenue result further comprises an annual net profit, the method further comprises:
obtaining product maintenance fees and product-incurred taxes for the target investment quantity of energy storage products; and
obtaining the annual net profit of the target investment quantity of energy storage products based on the product maintenance fees, the product-incurred taxes, the annual total charging cost and the annual total discharging revenue.

14. The method for determining the energy storage revenue according to claim 13, the method further comprising:
determining a degradation rate of the energy storage product;
periodically determining the actual total charging capacity and the total discharging capacity with the second preset duration as a cycle;
obtaining the annual total charging capacity by accumulating an actual charging capacity determined in each cycle;
obtaining the annual total discharging capacity by accumulating a discharging capacity determined in each cycle; and
determining, based on the degradation rate, future energy storage development data for the target investment quantity of energy storage products according to the annual total charging capacity, the annual total discharging capacity, and/or the energy storage revenue result, wherein the future energy storage development data comprises a future annual total charging capacity, a future annual total discharging capacity, a future annual total charging cost, and/or a future annual total discharging revenue.

15. The method for determining the energy storage revenue according to claim 14, wherein the method further comprises:
determining an energy storage economic indicator of the target investment quantity of energy storage products based on the energy storage revenue result and the usage performance data, the energy storage economic indicator comprising one or more of a net present value, a payback period, and an internal rate of return.

16. The method for determining the energy storage revenue according to claim 15, wherein the method further comprises:
generating a visual data report based on the energy storage revenue result, the annual net profit, the future energy storage development data and/or the energy storage economic indicator.

17. An electronic device, comprising:
at least one processor; and
a memory communicatively connected to the at least one processor;
wherein the memory stores a computer program executable by the at least one processor, the computer program when executed by the at least one processor, implements the operations of:
obtaining load data of an electricity consumption side and usage performance data of an energy storage product; and
determining an energy storage revenue result based on the load data of the electricity consumption side and the usage performance data.

18. The electronic device according to claim 17, wherein said determining the energy storage revenue result based on the load data of the electricity consumption side and the usage performance data comprises:
determining a target investment quantity of energy storage products based on the load data of the electricity consumption side; and
determining the energy storage revenue result for the target investment quantity of energy storage products based on the load data of the electricity consumption side and the usage performance data.

19. The electronic device according to claim 18, wherein the load data of the electricity consumption side at least comprises a first electricity load of the electricity consumption side during an off-peak period and a second electricity load of the electricity consumption side during a super-peak period, said determining the target investment quantity of the energy storage products based on the load data of the electricity consumption side comprises:
acquiring the first electricity load and the second electricity load periodically with a first preset duration as a cycle;
determining a first available charging capacity periodically based on a transformer capacity and the first electricity load;
accumulating the first available charging capacity determined in each cycle to obtain a total charging capacity at the electricity consumption side during the off-peak period;
accumulating the second electricity load determined in each cycle to obtain a required total discharging capacity of the electricity consumption side during the super-peak period; and
determining the target investment quantity based on the total charging capacity and the required total discharging capacity.

20. A non-transitory computer storage medium, on which a computer program is stored, wherein the computer program when executed by a processor, implements operations of:
obtaining load data of an electricity consumption side and usage performance data of an energy storage product; and
determining an energy storage revenue result based on the load data of the electricity consumption side and the usage performance data.
